(19) United States
(12) Patent Application Publication
(10) Pub. No.: US 2025/0172774 A1
(43) Pub. Date: May 29, 2025

(54) PHOTONIC SYSTEM WITH REMOVABLE FIBER ARRAY UNIT ASSEMBLY AND METHOD OF FORMING THE SAME

(71) Applicant: Taiwan Semiconductor Manufacturing Company, Ltd., Hsinchu (TW)

(72) Inventors: Wen-Chih LIN, Taoyuan City (TW); Cheng-Yu KUO, Kaohsiung City (TW); Yen-Hung CHEN, Hsinchu City (TW); Hsuan-Ting KUO, Taichung City (TW); Chia-Shen CHENG, Hsinchu County (TW); Chao-Wei LI, Hsinchu City (TW); Ching-Hua HSIEH, Hsinchu (TW); Wen-Chih CHIOU, Miaoli County (TW); Ming-Fa CHEN, Taichung City (TW); Shang-Yun HOU, Jubei City, Hsinchu (TW)

(73) Assignee: Taiwan Semiconductor Manufacturing Company, Ltd., Hsinchu (TW)

(21) Appl. No.: 18/519,744

(22) Filed: Nov. 27, 2023

(51) Int. Cl. G02B 6/42

(52) U.S. Cl. CPC G02B 6/4244; G02B 6/4204; G02B 6/4239; G02B 6/4274

(57) ABSTRACT

A photonic system is provided. The photonic system includes a substrate and a photonic structure bonded to the substrate, wherein the photonic structure includes one or more edge couplers. The photonic system also includes a fiber array unit (FAU) assembly attached to the sidewall of the photonic structure near the edge couplers. The FAU assembly includes a connection component, a FAU holding one or more optical fibers, and one or more micro-lenses. The connection component is secured to the sidewall through optical glue. The FAU is removably attached to the connection component through a pair of matching connection structures at an interface between the FAU and the connecting component. The micro-lenses are provided near the bottom of the connecting component and between the edge couplers and the optical fibers.

### BACKGROUND

One technique for signal transmission and processing is electrical signaling and processing. In addition, optical signaling and processing has been used in an increasing number of applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as for processing and control. Accordingly, devices that integrate optical components and electrical components are produced to convert between optical signals and electrical signals, as well as to process optical signals and electrical signals. Packages (also referred to as photonic packages) may therefore include both photonic dies including optical devices and electronic dies including electronic devices.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIGS. 1 to 11 illustrate cross-sectional views of intermediate steps of forming a photonic package, in accordance with some embodiments.

FIGS. 12 and 13 illustrate cross-sectional views of intermediate steps of forming a photonic structure, in accordance with some embodiments.

FIGS. 14 to 16 illustrate cross-sectional views of intermediate steps of forming a photonic system, in accordance with some embodiments.

FIGS. 17A and 17B illustrate cross-sectional views of a cover plate or a base plate of a fiber array unit (FAU) respectively, in accordance with some embodiments.

FIG. 18 illustrates a cross-sectional view of a FAU assembly, in accordance with some embodiments.

FIG. 19 illustrates a perspective exploded view of a portion of the FAU assembly of FIG. 18, in accordance with some embodiments.

FIGS. 20A and 20B respectively illustrate cross-sectional views of a connection component of a FAU assembly integrated with a micro-lens, in accordance with some embodiments.

FIG. 21 illustrates a cross-sectional view of a FAU assembly, in accordance with some embodiments.

FIG. 22 illustrates a flow chart of a method of coupling one or more optical fibers to a photonic structure, in accordance with some embodiments.

FIG. 23 illustrates a cross-sectional view of a FAU assembly, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The system may be otherwise oriented (rotated 90 degrees or at other orientations) and the spatially relative descriptors used herein may likewise be interpreted accordingly.

A photonic system and the method for forming the same are provided in accordance with some embodiments of the present disclosure. In the photonic system, a fiber array unit (FAU) assembly optically couples one or more optical fibers to one or more edge couplers within a photonic structure. The FAU assembly includes a FAU holding the optical fibers and a connecting component configured to connect (e.g., “edge-mount”) the FAU near a sidewall of the photonic structure. In some embodiments, the FAU is removably attached to the connecting component rather than being secured to the photonic structure by optical glue, which facilitates fiber replacement or repair. The FAU assembly may also include one or more micro-lenses provided close to the bottom of the connecting component between the one or more optical fibers and the one or more edge couplers to improve optical coupling. Furthermore, the FAU assembly may be attached to the photonic structure in an “upside-down” (i.e., overhang) manner and is not placed on the substrate of the photonic system, which helps to reduce the space taken up by the FAU assembly on the substrate. Accordingly, the size of the photonic system can be reduced. The Embodiments discussed herein provide examples to enable making or using the subject matter of this disclosure, and a person having ordinary skill in the art will readily understand that modifications can be made while remaining within the contemplated scope of different embodiments. Throughout the various views and illustrative embodiments, like reference numbers are used to designate like elements. Although method embodiments may be discussed as being performed in a particular order, other method embodiments may be performed in any logical order.

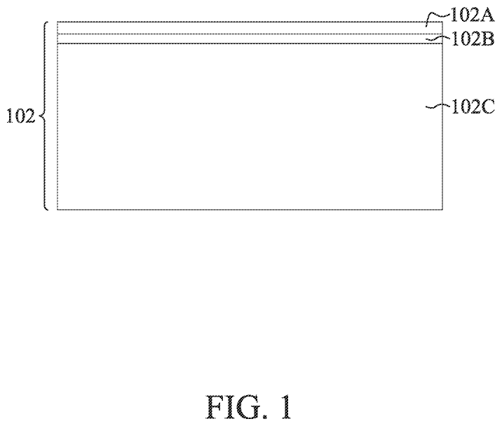

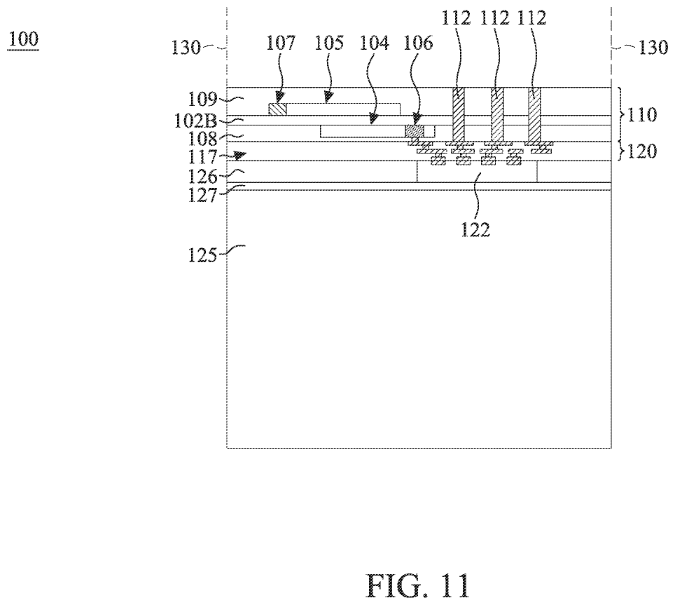

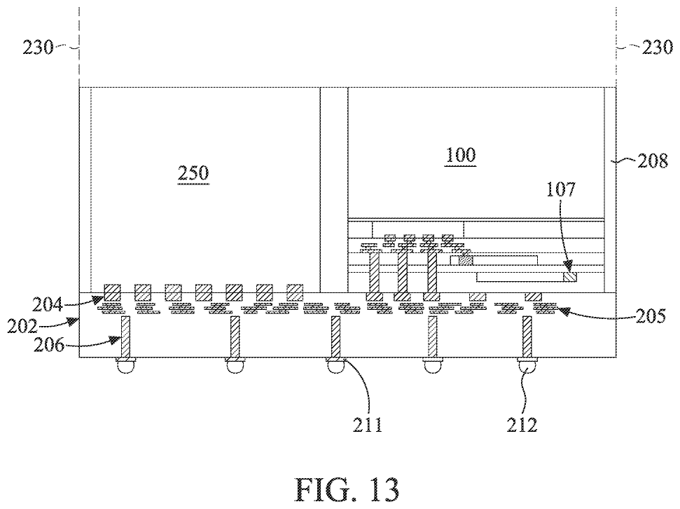

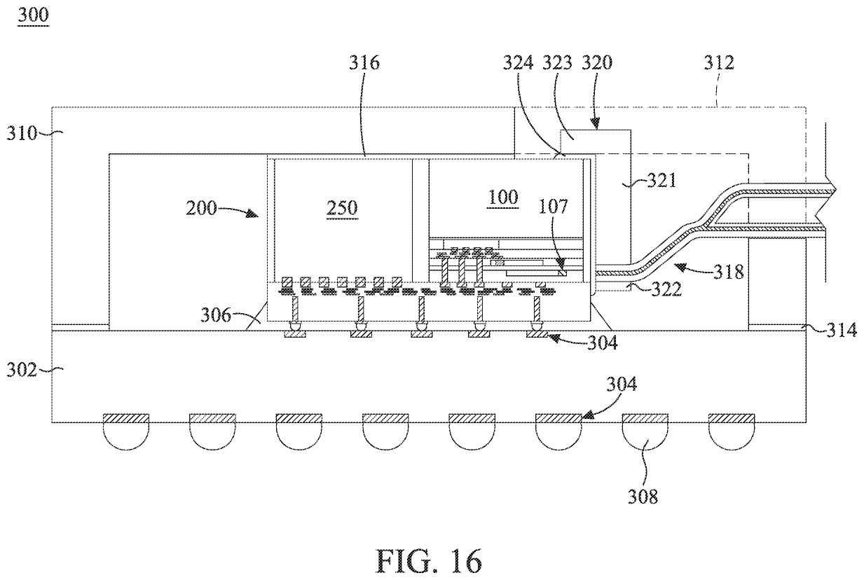

FIGS. 1 to 11 illustrate cross-sectional views of intermediate steps of forming a photonic package 100 (see FIG. 11), in accordance with some embodiments. In some cases, the photonic package 100 may act an input/output (I/O) interface between optical signals and electrical signals. For example, one or more photonic packages 100 may be used in a photonic structure such as the photonic structure 200 shown in FIG. 13, a photonic system such as the photonic system 300 shown in FIG. 16, or the like. In some cases, the photonic package 100 may be considered an “optical engine.”

Referring first to FIG. 1, a buried oxide (“BOX”) substrate 102 is provided, in accordance with some embodiments. The BOX substrate 102 includes an oxide layer 102B formed over a substrate 102C, and a silicon layer 102A formed over the oxide layer 102B. The substrate 102C may comprise a material such as glass, ceramic, dielectric, semiconductor, the like, or a combination thereof. In some embodiments, the substrate 102C is a semiconductor substrate, such as a bulk semiconductor substrate or the like, which may be doped or undoped. The substrate 102C may be a wafer, such as a silicon wafer or the like. Other substrates, such as a multi-layered or gradient substrate may also be used. In some embodiments, the semiconductor material of the substrate 102C may include silicon; germanium; a compound semiconductor including silicon carbide, gallium arsenic, gallium phosphide, indium phosphide, indium arsenide, and/or indium antimonide; an alloy semiconductor including silicon germanium, gallium arsenide phosphide, aluminum indium arsenide, aluminum gallium arsenide, gallium indium arsenide, gallium indium phosphide, and/or gallium indium arsenide phosphide; or a combination thereof. The oxide layer 102B may comprise, for example, a silicon oxide or the like.

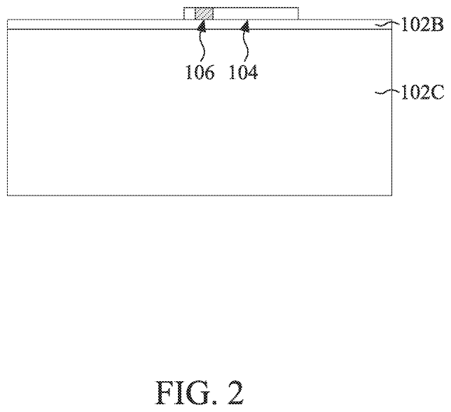

In FIG. 2, the silicon layer 102A is patterned to form silicon regions for waveguides 104 and photonic components 106, in accordance with some embodiments. The silicon layer 102A may be patterned using suitable photolithography and etching techniques. For example, a hard mask layer (e.g., a nitride layer, not shown) may be formed over the silicon layer 102A and patterned, in some embodiments. The pattern of the hard mask layer may then be transferred to the silicon layer 102A using one or more etching techniques, such as dry etching and/or wet etching techniques. For example, the silicon layer 102A may be etched to form recesses defining the waveguides 104, with sidewalls of the remaining unrecessed portions defining sidewalls of the waveguides 104. One waveguide 104 or multiple waveguides 104 may be patterned from the silicon layer 102A. If multiple waveguides 104 are formed, the multiple waveguides 104 may be individual separate waveguides 104 or connected as a single continuous structure. In some embodiments, one or more of the waveguides 104 form a continuous loop. Other configurations or arrangements of waveguides 104 may be used.

The photonic components 106 may be integrated with the waveguides 104, and may be formed with the waveguides 104, in some embodiments. The photonic components 106 may be physically or optically coupled to the waveguides 104 to interact with optical signals within the waveguides 104. The photonic components 106 may include, for example, photodetectors and/or modulators. For example, a photodetector may be optically coupled to a waveguide 104 to detect optical signals within the waveguide 104 and generate electrical signals corresponding to the optical signals. A modulator may be optically coupled to a waveguide 104 to receive electrical signals and generate corresponding optical signals within the waveguide 104 by modulating optical power within the waveguide 104. In this manner, the photonic components 106 can facilitate the input/output (I/O) of optical signals to and from the waveguides 104. Optical power may be provided to the waveguides 104, for example, by one or more optical fibers (not shown) coupled to an external light source, in some cases. In some embodiments, the photonic components 106 may include other active or passive components, such as laser diodes, optical signal splitters, mode converters, oscillators, phase shifters, interferometers, or other types of photonic structures or devices.

In some embodiments, the photodetectors may be formed by partially etching regions of the waveguides 104 and growing epitaxial material on the remaining silicon of the etched regions. The waveguides 104 may be etched using acceptable photolithography and etching techniques. The epitaxial material may comprise, for example, a semiconductor material such as germanium, which may be doped or undoped. In some embodiments, an implantation process may be performed to introduce dopants (e.g., p-type dopants, n-type dopants, or a combination) within the silicon of the etched regions as part of the formation of the photodetectors. In some embodiments, the modulators may be formed by, for example, partially etching regions of the waveguides 104 and then implanting appropriate dopants within the remaining silicon of the etched regions. In some embodiments, the etched regions used for the photodetectors and the etched regions used for the modulators may be formed using one or more of the same photolithography or etching step. In some embodiments, the etched regions used for the photodetectors and the etched regions used for the modulators may be implanted using one or more of the same implantation steps.

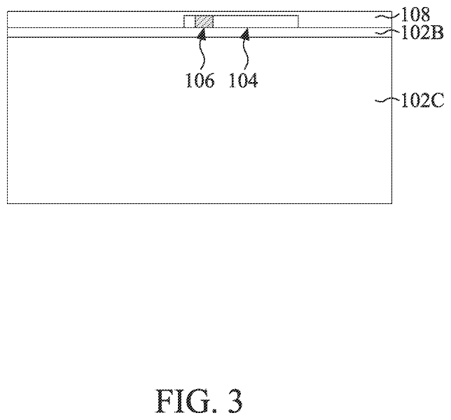

In FIG. 3, a dielectric layer 108 is formed on the front side (e.g., the side facing upwards in FIG. 3) of the BOX substrate 102, in accordance with some embodiments. The dielectric layer 108 is formed over the waveguides 104, the photonic components 106, and the oxide layer 102B. The dielectric layer 108 may be formed of one or more layers of silicon oxide, silicon nitride, a combination thereof, or the like, and may be formed by any acceptable deposition process, such as chemical vapor deposition (CVD), physical vapor deposition (PVD), atomic layer deposition (ALD), spin coating, laminating, the like, or a combination thereof. Other suitable dielectric materials formed by any acceptable process may be used. In some embodiments, the dielectric layer 108 is then planarized using a planarization process such as a chemical-mechanical polishing (CMP) process, a grinding process, or the like.

Due to the difference in refractive indices of the materials of the waveguides 104 and dielectric layer 108, the waveguides 104 have high internal reflections so that light is substantially confined within the waveguides 104, depending on the wavelength of the light and the refractive indices of the respective materials. In some embodiments, the refractive index of the material of the waveguides 104 is higher than the refractive index of the material of the dielectric layer 108. For example, the waveguides 104 may comprise silicon, and the dielectric layer 108 may comprise silicon oxide or silicon nitride. Other materials may be used.

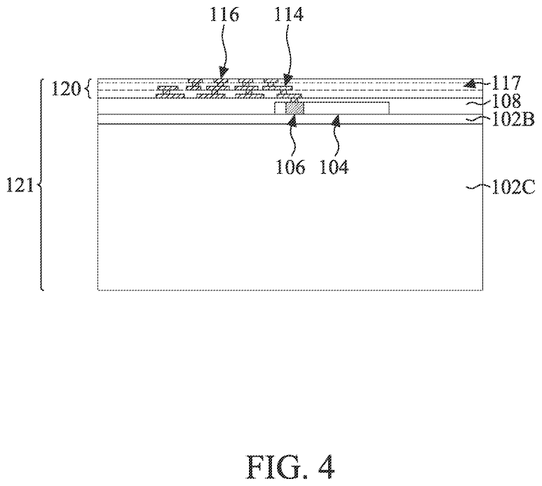

In FIG. 4, a redistribution structure 120 is formed over the dielectric layer 108, in accordance with some embodiments. The redistribution structure 120 includes conductive features 114 formed in one or more dielectric layers 117, and may provide interconnections and electrical routing. The dielectric layers 117 may comprise one or more materials similar to those described above for the dielectric layer 108, such as a silicon oxide or a silicon nitride, although other dielectric materials may be used. The dielectric layers 117 and dielectric layer 108 may be transparent or nearly transparent to light within the same range of wavelengths, in some embodiments. The dielectric layers 117 may be formed using a technique similar to those described above for the dielectric layer 108 or using a different technique.

The conductive features 114 may include conductive lines, conductive vias, and conductive pads 116. The conductive features 114 may be formed using a damascene process (e.g., single damascene, duel damascene), the like, or other suitable processes. The conductive features 114 may comprise a metal or a metal alloy including aluminum, copper, tungsten, or the like, although other conductive materials may be used. As shown in FIG. 4, conductive pads 116 are formed in the topmost layer of the dielectric layers 117. A planarization process (e.g., a CMP process or the like) may be performed after forming the conductive pads 116 such that top surfaces of the conductive pads 116 and the topmost dielectric layer 117 are substantially coplanar or level. In some cases, the topmost dielectric layer 117 may comprise a material suitable for dielectric-to-dielectric bonding, and may thus be considered a “bonding layer.” The redistribution structure 120 may include more or fewer dielectric layers 117, conductive features 114, or conductive pads 116 than shown in FIG. 4, and may have a different arrangement or configuration.

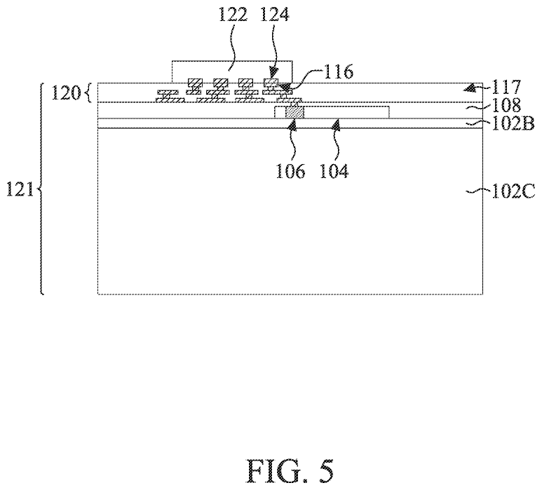

In some embodiments, the redistribution structure 120 may comprise one or more contacts (not separately marked) that are electrically connected to one or more photonic components 106. The contacts may extend through portions of the dielectric layer 108, in some cases. The contacts to the photonic components 106 allow electrical power or electrical signals to be transmitted to the photonic components 106 and electrical signals to be transmitted from the photonic components 106. In this manner, the photonic components 106 may convert electrical signals (e.g., from an electronic die 122, see FIG. 5) into optical signals transmitted by the waveguides 104, and it may also convert optical signals from the waveguides 104 into electrical signals (which may be received by an electronic die 122). In some cases, the structure shown in FIG. 4 may be considered to include one or more photonic dies 121.

In FIG. 5, one or more electronic dies 122 are bonded to the redistribution structure 120, in accordance with some embodiments. The electronic dies 122 may be, for example, semiconductor devices, dies, or chips that communicate with the photonic dies 121 using electrical signals. In the illustrated embodiments, the electronic die 122 does not receive, transmit, or process optical signals. In the discussion herein, the term “electronic die” is used to distinguish from “photonic die” (e.g., 121), which refers to a die that can receive, transmit, or process optical signals, such as converting an optical signal into an electric signal, or vice versa. Besides optical signals, the photonic die 121 may also transmit, receive, or process electrical signals. One electronic die 122 is shown in FIG. 5, but a photonic package 100 may include two or more electronic dies 122 in some other embodiments. In some cases, multiple electronic dies 122 may be incorporated into a single photonic package 100 in order to reduce processing cost. The electronic die 122 may include die connectors 124, which may be, for example, conductive pads, conductive pillars, or the like.

The electronic die 122 may include integrated circuits (not individually shown) for controlling the operation of the photonic components 106. For example, the electronic die 122 may include controllers, drivers, transimpedance amplifiers, the like, or combinations thereof. The electronic die 122 may include a central processing unit (CPU) or memory functionality, in some embodiments. In some embodiments, the electronic die 122 includes integrated circuits for processing electrical signals received from photonic components 106 (e.g., photodetectors). The electronic die 122 may control high-frequency signaling of the photonic components 106 according to electrical signals received from another device or die, in some embodiments. In some embodiments, the electronic die 122 may be an electronic integrated circuit (EIC) or the like that provides Serializer/Deserializer (SerDes) functionality. In this manner, the electronic die 122 may act as part of an I/O interface between optical signals and electrical signals within a photonic package 100, and the photonic packages 100 described herein can be considered system-on-chip (SoC) or system-on-integrated-circuit (SoIC) devices.

In some embodiments, the electronic die 122 is bonded to the redistribution structure 120 by dielectric-to-dielectric bonding and/or metal-to-metal bonding (e.g., direct bonding, fusion bonding, oxide-to-oxide bonding, hybrid bonding, or the like). In such embodiments, covalent bonds may be formed between oxide layers, such as the topmost dielectric layer 117 and the surface dielectric layer (not separately indicated) of the electronic die 122. During the bonding, metal-to-metal bonding may also occur between the die connectors 124 of the electronic die 122 and the conductive pads 116 of the redistribution structure 120.

In some embodiments, before performing the bonding process, a surface treatment is performed on the redistribution structure 120 and/or the electronic die 122. In some embodiments, the bonding surfaces of the redistribution structure 120 and/or the electronic die 122 may first be activated utilizing, for example, a dry treatment, a wet treatment, a plasma treatment, exposure to an inert gas, exposure to H₂, exposure to N₂, exposure to O₂, the like, or a combination thereof. However, any suitable activation process may be utilized. After the activation process, the redistribution structure 120 and/or the electronic die 122 may be cleaned using, e.g., a chemical rinse. The electronic die 122 is then aligned with the redistribution structure 120 and placed into physical contact with the redistribution structure 120 using, for example, a pick-and-place process. The redistribution structure 120 and the electronic die 122 may then be subjected to a thermal treatment and/or pressed against each other (e.g., by applying contact pressure) to bond the redistribution structure 120 and the electronic die 122. For example, the redistribution structure 120 and the electronic die 122 may be subjected to a pressure of about 200 kPa or less, and to a temperature in the range of about 200° C. to about 400° C. The redistribution structure 120 and the electronic die 122 may then be subjected to a temperature at or above the eutectic point of the material of the top-most conductive features 114 and the die connectors 124 (e.g., a temperature in the range of about 150° C. to about 650° C.) to fuse the top-most conductive features 114 and the die connectors 124. In this manner, the dielectric-to-dielectric bonding and/or metal-to-metal bonding of the redistribution structure 120 and the electronic die 122 forms a bonded structure. In some embodiments, the bonded structure is baked, annealed, pressed, or otherwise treated to strengthen or finalize the bonds.

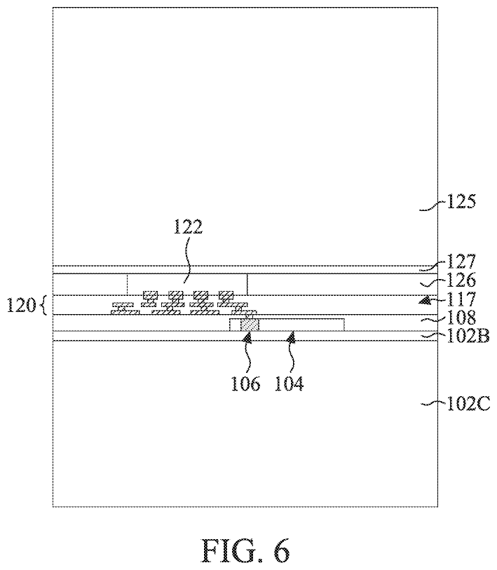

In FIG. 6, a dielectric material 126 is formed over the electronic die 122 and the redistribution structure 120, in accordance with some embodiments. The dielectric material 126 may be formed of silicon oxide, silicon nitride, a polymer, the like, or a combination thereof. The dielectric material 126 may be formed by CVD, PVD, ALD, a spin coating process, the like, or a combination thereof. The dielectric material 126 may be a gap-filling material in some embodiments, which may include one or more of the example materials above. Other dielectric materials formed by any acceptable process may be used. The dielectric material 126 may be planarized using a planarization process such as a CMP process, a grinding process, or the like. In some embodiments, the planarization process may expose the electronic die 122 such that top surfaces of the electronic die 122 and the dielectric material 126 are substantially coplanar or level.

Also illustrated in FIG. 6, an optional support 125 is attached to the above structure, in accordance with some embodiments. The support 125 is a rigid structure that is attached to the structure in order to provide structural or mechanical stability. The use of the support 125 can reduce warping or bending, which can improve the performance of the optical structures such as the waveguides 104 or photonic components 106. The support 125 may comprise one or more materials such as silicon (e.g., a silicon wafer or the like), silicon oxide, silicon oxynitride, silicon carbonitride, a metal, an organic core material, or the like. The support 125 may be attached to the structure (e.g., to the dielectric material 126 and/or the electronic dies 122) using an adhesive layer 127, as shown in FIG. 6. In some other embodiments, the support 125 may be attached using direct bonding (e.g., dielectric-to-dielectric bonding or fusion bonding) or another suitable technique. The support 125 may also have lateral dimensions (e.g., length, width, and/or area) that are greater than, about the same as, or smaller than those of the structure. In some embodiments, the support 125 may be subsequently thinned using a CMP process, grinding process, or the like.

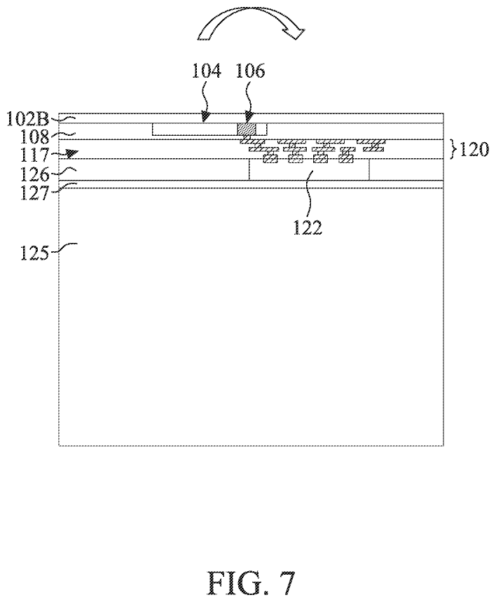

In FIG. 7, the resulting structure in FIG. 6 is flipped over and the substrate 102C is removed, in accordance with some embodiments. The structure may be attached to a temporary carrier (not shown) prior to removal of the substrate 102C, in some cases. The substrate 102C may be removed to expose the oxide layer 102B, in accordance with some embodiments. The substrate 102C may be removed using a CMP process, a mechanical grinding, an etching process, the like, or a combination thereof. In some embodiments, the oxide layer 102B is also thinned during removal of the substrate 102C or using a separate process step.

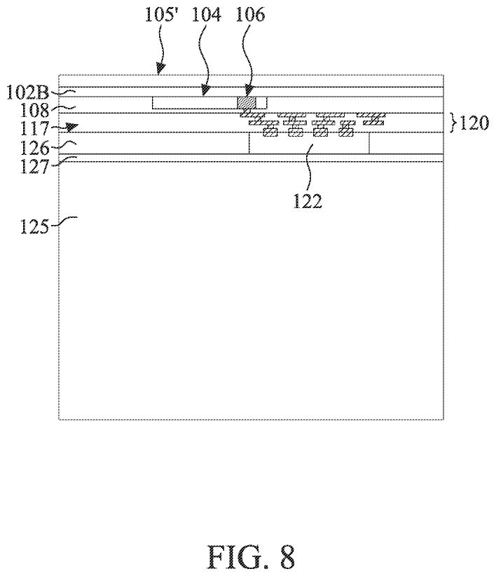

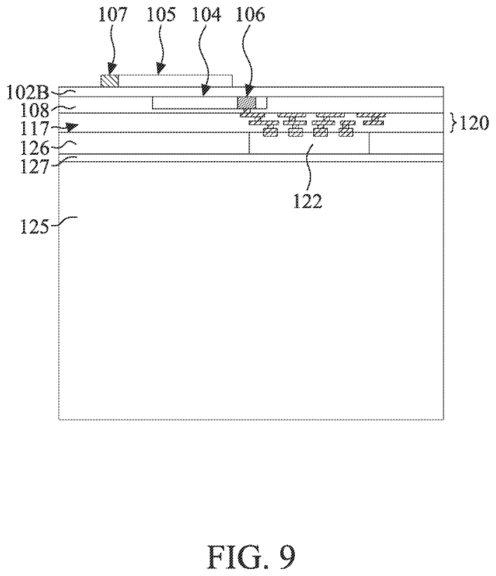

FIGS. 8 and 9 illustrate the formation of waveguides 105 over the oxide layer 102B, in accordance with some embodiments. The waveguides 105 may provide additional routing of optical signals, and may include one or more edge couplers 107 for interfacing with external optical components, which will described in greater detail below. The waveguides 105 may be optically coupled to one or more waveguides 104 and/or one or more photonic components 106. For example, a waveguide 105 may be evanescently coupled to a waveguide 104 through the oxide layer 102B, although other coupling techniques may be used. In some cases, forming additional waveguides 105 on the oxide layer 102B rather than on the dielectric layer 108 may allow for improved formation of waveguides 105, improved optical coupling to the waveguides 104, reduced optical loss, and increased efficiency.

In FIG. 8, a waveguide material 105′ is deposited over the oxide layer 102B, in accordance with some embodiments. The waveguide material 105′ may be a material similar to or different than the material of the waveguides 104. For example, the waveguide material 105′ may be a material such as silicon, silicon nitride, or the like. The waveguide material 105′ may be deposited using a suitable technique, such as CVD, PVD, ALD, or the like.

In FIG. 9, the waveguide material 105′ is patterned to form waveguides 105, in accordance with some embodiments. The waveguide material 105′ may be patterned using similar photolithography and etching techniques as described above for the waveguides 104. One waveguide 105 or multiple waveguides 105 may be patterned from the waveguide material 105′. If multiple waveguides 105 are formed, the multiple waveguides 105 may be individual separate waveguides 105 or connected as a single continuous structure. In some embodiments, one or more of the waveguides 105 form a continuous loop. Other configurations or arrangements of waveguides 105 may be used.

In some embodiments, one or more edge couplers 107 may be integrated with the waveguides 105, and may be formed with the waveguides 105. The edge couplers 107 may be continuous with the waveguides 105 and may be formed in the same processing steps as the waveguides 105. An edge coupler 107 allows optical signals and/or optical power to be transferred between a waveguide 105 and external optical component that is “edge-mounted” near a sidewall of the photonic package 100, such as an optical fiber or a waveguide of another photonic system, which will described in greater detail below. The edge couplers 107 may be formed using acceptable photolithography and etching techniques. In some other embodiments, the edge couplers 107 are formed after formation of the waveguides 105.

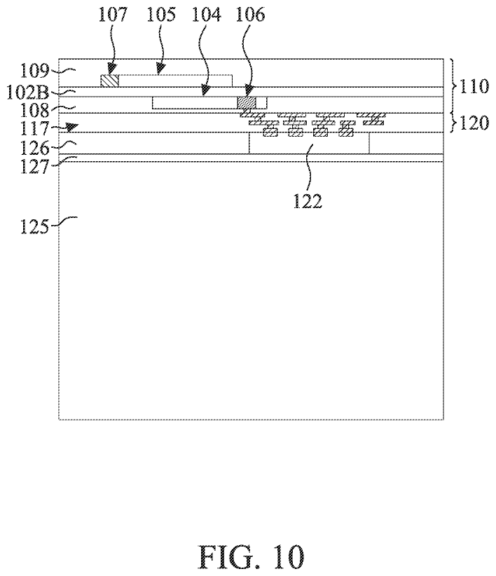

In FIG. 10, a dielectric layer 109 is formed over the waveguides 105, the edge couplers 107 and the oxide layer 102B, in accordance with some embodiments. The dielectric layer 109 may be formed of one or more layers of silicon oxide, silicon nitride, a combination thereof, or the like, and may be formed by CVD, PVD, ALD, a spin coating process, the like, or a combination thereof. In some embodiments, the dielectric layer 109 comprises a material similar to that of the oxide layer 102B and/or the dielectric layer 108. Other dielectric materials formed by any acceptable process may be used. In some embodiments, the dielectric layer 109 is then planarized using a planarization process such as a CMP process, a grinding process, or the like.

FIGS. 8 to 10 illustrate the formation of one layer of waveguides 105 within one dielectric layer 109, but in some other embodiments multiple layers of waveguides 105 may be formed within multiple dielectric layers 109. The multiple layers of waveguides 105 may be formed by repeating the techniques described above for forming a single layer of waveguides 105. In such embodiments, different layers of waveguides 105 may be optically coupled to each other using evanescent coupling or the like. In some embodiments, one or more edge couplers 107 may be formed in any appropriate layers of waveguides 105. In some cases, the dielectric layer 109 or the topmost dielectric layer 109 may comprise a material suitable for dielectric-to-dielectric bonding, and may thus be considered a “bonding layer.” In some cases, the waveguides 104, waveguides 105, photonic components 106, and edge couplers 107 may be collectively referred to herein as a photonic routing structure 110. In this manner, a photonic routing structure 110 may be formed on the redistribution structure 120.

In FIG. 11, conductive vias 112 are formed extending through the photonic routing structure 110 to electrically contact the redistribution structure 120, in accordance with some embodiments. The conductive vias 112 may be formed, for example, by forming openings (not separately shown) extending through the dielectric layer(s) 109, the oxide layer 102B, and the dielectric layer 108. The openings may be formed by acceptable photolithography and etching techniques, and may expose conductive features 114 (see FIG. 4) of the redistribution structure 120.

A conductive material is then deposited in the openings, thereby forming the conductive vias 112, in accordance with some embodiments. In some embodiments, a liner (not shown), such as a diffusion barrier layer, an adhesion layer, or the like, may be deposited in the openings from materials such as tantalum nitride, tantalum, titanium nitride, titanium, cobalt tungsten, or the like, and may be formed using a suitable deposition process such as ALD or the like. In some embodiments, a seed layer (not shown), which may include copper or a copper alloy, may then be deposited in the openings. The conductive material of the conductive vias 112 is then formed in the openings using, for example, electroplating or electro-less plating. The conductive material may include, for example, a metal or a metal alloy such as copper, silver, gold, tungsten, cobalt, aluminum, ruthenium, alloys thereof, or the like. A planarization process (e.g., a CMP process or a grinding process) may be performed to remove excess conductive material along the top surface of the dielectric layer(s) 109, such that top surfaces of the conductive vias 112 and the dielectric layer(s) 109 are substantially coplanar or level.

After formation of the conductive vias 112, a singulation process may be performed by, for example, sawing along scribed lines 130 of the resulting package structure to separate multiple photonic packages 100 within the package structure into individual photonic packages 100 (only one photonic package 100 is shown in FIG. 11), in accordance with some embodiments. The singulation process may comprise sawing through the package structure (including the support 125 and various components thereon, as described above) using a mechanical saw or another suitable process. The photonic package 100, by integrating photonic die 121 and electronic die 122 in the same package, allows for co-package optics (CPO) integration (i.e., with reduced package size and shorter signal transmission path), and achieves high bandwidth with ultra-low power consumption.

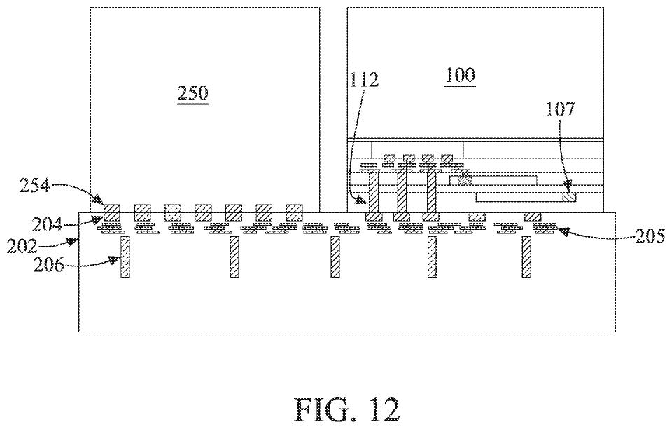

FIGS. 12 and 13 illustrate the formation of a photonic structure 200 (see FIG. 13), in accordance with some embodiments. The photonic structure 200 may comprise at least one photonic package 100 (as described above) and at least one semiconductor device 250 connected to an interconnect substrate 202, in some embodiments. The semiconductor device(s) 250 may be, for example, semiconductor devices, chips, dies, system-on-chip (SoC) devices, system-on-integrated-circuit (SoIC) devices, the like, or a combination thereof. The semiconductor device(s) 250 may include one or more processing devices, such as a central processing unit (CPU), a graphics processing unit (GPU), an application-specific integrated circuit (ASIC), a high performance computing (HPC) die, the like, or a combination thereof. The semiconductor device(s) 250 may include one or more memory devices, such as dynamic random-access memory (DRAM), static random-access memory (SRAM), high-bandwidth memory (HBM), or the like. Other types of semiconductor devices or combinations of semiconductor devices may be used. In some other embodiments, the semiconductor device(s) 250 may be omitted from the photonic structure 200.

In some embodiments, the interconnect substrate 202 comprises conductive pads 204, conductive routing 205, and through substrate vias (TSVs) 206. The conductive routing 205 may provide electrical interconnections, and may electrically couple the conductive pads 204 and the TSVs 206. The conductive routing 205 may comprise one or more layers of conductive lines, conductive vias, redistribution layers, metallization patterns, or the like. In some cases, the interconnect substrate 202 may comprise an interposer substrate (e.g., silicon interposer), a redistribution layer (RDL) substrate, a core substrate, or another suitable type of substrate. In some embodiments, the interconnect substrate 202 may or may not include active and/or passive devices.

In some embodiments, the photonic package 100 and the semiconductor device 250 are bonded to the interconnect substrate 202 by dielectric-to-dielectric bonding and/or metal-to-metal bonding (e.g., direct bonding, fusion bonding, oxide-to-oxide bonding, hybrid bonding, or the like). In such embodiments, covalent bonds may be formed between oxide layers, such as the topmost dielectric layer of the interconnect substrate 202 and surface dielectric layers (not separately marked) of the photonic package 100 and/or the semiconductor device 250. During the bonding, metal-to-metal bonding may also occur between conductive pads 254 of the semiconductor device 250 and conductive pads 204 of the interconnect substrate 202, and may occur between conductive vias 112 or conductive pads (if present) of the photonic package 100 and conductive pads 204 of the interconnect substrate 202. The bonding process may be similar to the bonding process described previously for the electronic die 122 (see FIG. 5). In this manner, the photonic package 100 and the semiconductor device 250 may be electrically coupled to the conductive routing 205 and/or the TSVs 206.

In FIG. 13, an encapsulant 208 is formed on the interconnect substrate 202 to encapsulate the photonic package(s) 100 and the semiconductor device(s) 250, in accordance with some embodiments. The encapsulant 208 may be a molding compound, epoxy, or the like, and may be applied by compression molding, transfer molding, or the like. The encapsulant 208 may be applied in liquid or semi-liquid form and then subsequently cured. Other materials or deposition techniques may be used. In some embodiments, a planarization process (e.g., a CMP process, grinding process, or the like) is performed after formation of the encapsulant 208. In some embodiments, top surfaces of the photonic package 100 and/or the semiconductor device 250 may be exposed by the planarization process. In some embodiments, after the planarization process, top surfaces of the encapsulant 208, photonic package(s) 100, and/or the semiconductor device(s) 250 may be substantially level or coplanar.

Also illustrated in FIG. 13, conductive connectors 212 are formed on the interconnect substrate 202, in accordance with some embodiments. The conductive connectors 212 may be formed, for example, by thinning the back side (e.g., the side facing downwards in FIG. 13) of the interconnect substrate 202 to expose the TSVs 206. The thinning may be achieved using a planarization process (e.g., a CMP process, a grinding process), an etching process, or the like. In some embodiments, conductive pads 211 are formed on the exposed TSVs 206, and the conductive connectors 212 are formed on the conductive pads 211. The conductive pads 211 and the conductive connectors 212 may be electrically connected to the conductive routing 205 by the TSVs 206. In some embodiments, the conductive pads 211 may comprise under-bump metallizations (UBMs). In some other embodiments, the conductive pads 211 are not formed. Further details of the conductive pads 211 are not discussed here.

The conductive connectors 212 may be, for example, ball grid array (BGA) connectors, solder balls, metal pillars, controlled collapse chip connection (C4) bumps, micro bumps, electroless nickel-electroless palladium-immersion gold technique (ENEPIG) formed bumps, or the like. The conductive connectors 212 may comprise a conductive material such as solder, copper, aluminum, gold, nickel, silver, palladium, tin, the like, or a combination thereof. In some embodiments, the conductive connectors 212 are formed by initially forming a layer of solder using a suitable technique such as evaporation, electroplating, printing, solder transfer, ball placement, or the like. Once a layer of solder has been formed on the structure, a reflow may be performed in order to shape the material into the desired bump shapes. Other materials or techniques for forming the conductive connectors 212 may be used.

Still referring to FIG. 13, a singulation process may then be performed by, for example, sawing along scribed lines 230 of the resulting package structure to separate multiple photonic structures 200 within the package structure into individual photonic structures 200 (only one photonic structure 200 is shown is shown in FIG. 13), in accordance with some embodiments. The singulation process may comprise sawing through the package structure (including the interconnect substrate 202 and various components thereon, as described above) using a mechanical saw or another suitable process.

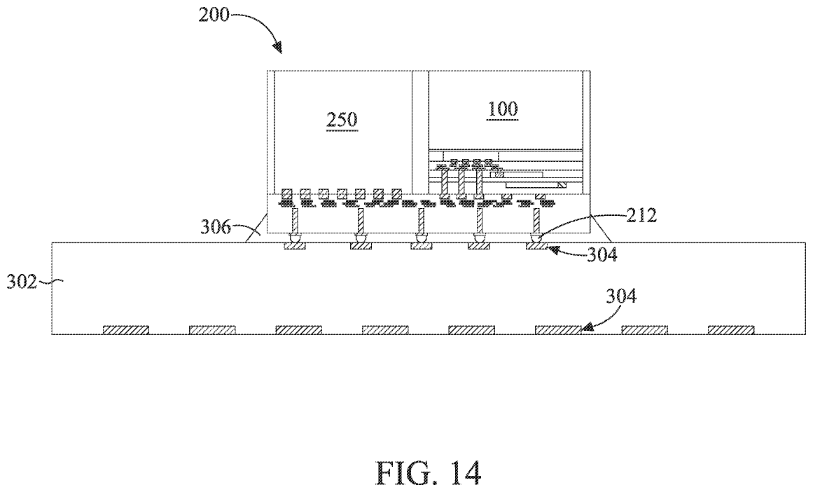

FIGS. 14 to 16 illustrate the formation of a photonic system 300 (see FIG. 16), in accordance with some embodiments. The photonic system 300 may comprise at least one photonic structure 200 (as described above) that is optically coupled to one or more optical fibers 318 (see FIG. 16). In this manner, optical signals and/or optical power may be transmitted to or from the photonic structure 200. For example, optical signals may be transmitted from an optical fiber 318 into the photonic structure 200. The optical signals may be processed or analyzed by the photonic structure 200, and the photonic structure 200 may generate other optical signals and transmit them to the optical fiber 318. This is an example, and other applications are possible. The photonic system 300 may sometimes be referred to herein as a “photonic semiconductor device”.

In FIG. 14, a photonic structure 200 is attached (e.g., bonded) to an package substrate 302, in accordance with some embodiments. The package substrate 302 may comprise an interposer substrate, a semiconductor substrate, a redistribution layer (RDL) substrate, a core substrate, or a different type of structure than these examples. The package substrate 302 may include conductive features (e.g., conductive lines and/or vias, not shown for simplicity) connecting conductive pads 304 on both sides of the package substrate 302. In some embodiments, the package substrate 302 includes active and/or passive devices. In other embodiments, the package substrate 302 is free of active and/or passive devices. In some embodiments, the photonic structure 200 is bonded to the package substrate 302 by placing the conductive connectors 212 of the photonic structure 200 above the upper conductive pads 304 of the package substrate 302 and then performing a reflow process. In this manner, the photonic structure 200 may be physically and electrically coupled to the package substrate 302 through the conductive connectors 212. Although not shown, one or more other semiconductor devices or chips may be bonded to the package substrate 302 to provide additional functionality of the photonic system 300.

Also illustrated in FIG. 14, an underfill material 306 is formed over the package substrate 302 around the photonic structure 200. The underfill material 306 may flow underneath the photonic structure 200 and into gaps between the conductive connectors 212 to enhance the connection between the photonic structure 200 and the package substrate 302. The underfill material may include an epoxy, a resin, a filler material, a stress release agent (SRA), an adhesion promoter, another suitable material, or a combination thereof. In some embodiments, the underfill material may be applied in liquid form and then cured.

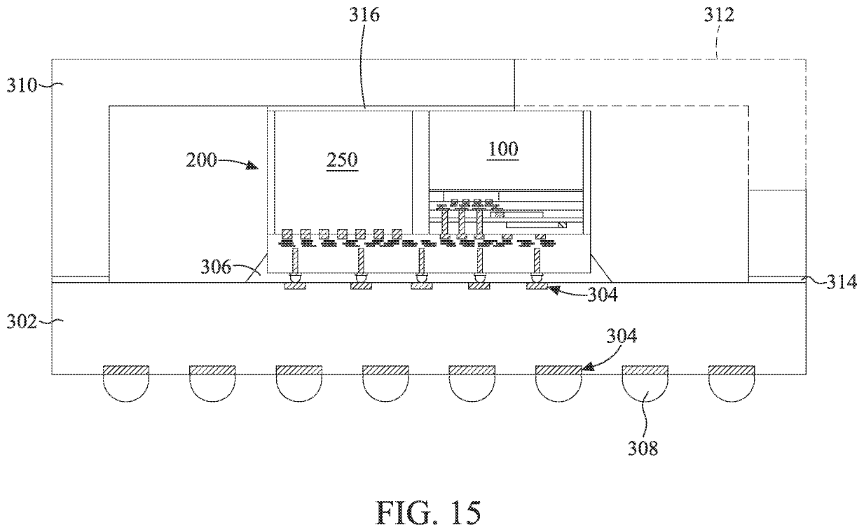

In FIG. 15, a lid 310 is attached to the package substrate 302, in accordance with some embodiments. The provision of the lid 310 helps to reduce warpage of the package substrate 302. The lid 310 may be attached to the package substrate 302 by, for example, an adhesive material 314. A center portion of the lid 310 may contact the photonic structure 200 (e.g., the photonic package(s) 100 and/or the semiconductor device(s) 250), either directly or through a thermal interface material (TIM) 316, in order to facilitate heat dissipation. In such cases, the material of the lid 310 may include metal such as copper, stainless steel, stainless steel/Ni, or the like, but is not limited thereto. In some embodiments, the lid 310 further has one or more openings 312 that allow for the subsequent attachment and coupling of optical fibers 318 (see FIG. 16) to the photonic structure 200. In some other embodiments, the lid 310 may be replaced by a stiffener ring.

Also illustrated in FIG. 15, electrical connectors 308 are formed on the lower conductive pads 304 of the package substrate 302, in accordance with some embodiment. Through the electrical connectors 308, the photonic system 300 may be physically and electrically connected to another device or system. The electrical connectors 308 may be formed using the materials and techniques described above for forming the conductive connectors 212.

In FIG. 16, one or more optical fibers 318 are attached to the lid 310 and are optically coupled to the photonic structure 200 to form a photonic system 300, in accordance with some embodiments. The optical fibers 318 may be individual optical fibers 318 or may be packaged in a fiber array (e.g., one-dimensional (1-D) or two-dimensional (2D) array) or similar configuration. In some embodiments, one or more optical fibers 318 may be secured (e.g., “edge-mounted”) near a sidewall of the photonic structure 200 by a fiber array unit (FAU) 320. Also, each optical fiber 318 is optically coupled to a corresponding edge coupler 107 within the photonic structure 200 (e.g., within the photonic package 100) such that optical signals and/or optical power may be transmitted between the photonic structure 200 and the optical fibers 318. Therefore, the optical fibers 318 may be considered to be “edged-coupled” to the edge couplers 107 within the photonic structure 200.

In some cases, the end of each optical fiber 318 that is opposite the photonic structure 200 may be coupled to an optical interconnect (e.g., an MT ferrule, not shown) that is coupled to a light source (not shown). In some embodiments, the optical fibers 318 may be secured to the lid 310 using a glue (not shown), which may be an adhesive, an optical glue, or the like. A lid cover (not shown) may be present over the openings 312 to cover and protect the optical fibers 318, in some embodiments.

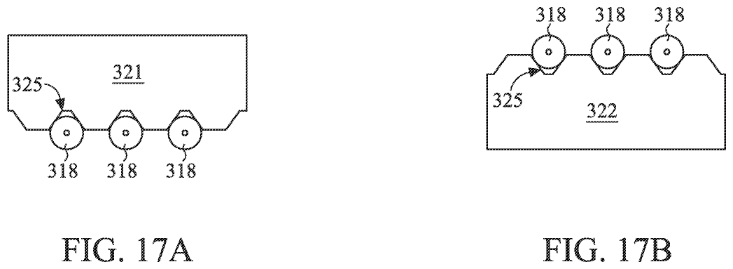

The FAU 320 is used to hold the optical fibers 318, and may thus be considered an “optical fiber holder” or the like. In some embodiments, the FAU 320 includes a cover (or upper) plate 321 and a base (or lower) plate 322 that hold the optical fibers 318 therebetween, as shown in FIG. 16. In this manner, the FAU 320 can facilitate the vertical alignment of an optical fiber 318 with its corresponding edge coupler 107. The FAU 320 may also have multiple grooves (e.g., recesses, see 325 in FIGS. 17A and 17B), with an optical fiber 318 held within each groove 325. In some cases, grooves 325 may be formed on the lower side (facing the base plate 322) of the cover plate 321 (as shown in FIG. 17A), or may be formed on the upper side (facing the cover plate 321) of the base plate 322 (as shown in FIG. 17B). The grooves 325 shown in FIGS. 17A and 17B are merely examples, and a FAU 320 may have a different number of grooves 325 (corresponding to the number of optical fibers 318 held) than shown, or the grooves 325 may have a different shape or different dimensions than shown. A glue (not shown) such as adhesive, an optical glue, or the like may further be applied to help secure the optical fibers 318 in the corresponding grooves 325, in some cases. The cover plate 321 and/or the base plate 322 of the FAU 320 may be formed of one or more materials such as silicon (e.g., bulk silicon), silicon oxide, ceramic, glass, polymer, metal, metal alloy, the like, or a combination thereof. In some other embodiments, the base plate 322 may not be present.

In some embodiments, the FAU 320 has a substantially “inverted L-shaped” structure, as shown in FIG. 16. For example, the cover plate 321 has a lateral protrusion 323 extending laterally from the top. In some embodiments, the opening 312 of the lid 310 extends over the photonic structure 200 such that a top surface region of the photonic structure 200 is not covered by the lid 310. As shown in FIG. 16, the FAU 320 is oriented within the photonic system 300 such that the lateral protrusion 323 of the cover plate 321 may extend over (e.g., overhang or rest on) the photonic structure 200. In other words, the photonic structure 200 may support the lateral protrusion 323 of the FAU 320. In some embodiments, the shape of the FAU 320 (e.g., cover plate 321) may be formed such that resting the lateral protrusion 323 on the photonic structure 200 also vertically aligns the optical fibers 318 with their corresponding edge couplers 107. In this manner, alignment of the optical fibers 318 to the edge couplers 107 may be facilitated. In some cases, the orientation of the FAU 320 described above may be considered “upside-down.” By attaching the FAU 320 with the optical fibers 318 close to the bottom of the FAU 320 (or the cover plate 321), the optical fibers 318 may be positioned closer to package substrate 302. This allows the edge couplers 107 of the photonic structure 200 to be formed closer to the bottom of the photonic structure 200. In this manner, the overall height of the photonic structure 200 and/or the photonic system 300 may be reduced.

In some embodiments, an optical glue 324 may be deposited between the photonic structure 200 and the FAU 320. The optical glue 324 may secure the optical fibers 318 and/or the FAU 320, and may facilitate optical coupling between an edge coupler 107 and its corresponding optical fiber 318. In some embodiments, the optical glue 324 may extend between the sidewall of the photonic structure 200 (near the edge couplers 107) and the surfaces of the optical fibers 318 and/or the FAU 320 (near the edge couplers 107). In some embodiments, the optical glue 324 may also extend between the top surface of the photonic structure 200 and the bottom surface of the lateral protrusion 323 of the FAU 320. In some embodiments, the optical glue 324 may be deposited after aligning optical fibers 318 with corresponding edge couplers 107 using the FAU 320.

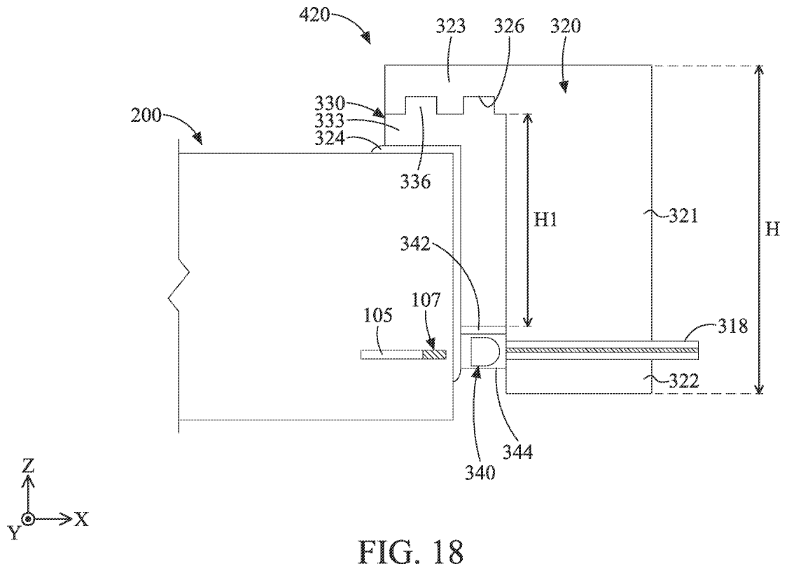

In some embodiments, the optical fiber 318 (such as its bends) may be easily damaged and need to be replaced. Securing the FAU 320 to the sidewall of the photonic structure 200 with optical glue 324 does not facilitate fiber replacement. FIG. 18 illustrates a cross-sectional view of a fiber array unit (FAU) assembly 420 that can address the above issues in accordance with some embodiments, and FIG. 18 also illustrates the assembly of the FAU assembly 420 to the photonic structure 200.

As shown in FIG. 18, in addition to the FAU 320 discussed above, the FAU assembly 420 also includes a mounting component 330. The FAU 320 is removably attached to the photonic structure 200 through the mounting component 330. For example, the mounting component 330 has substantially “inverted L-shaped” structure similar to the FAU 320, and the mounting component 330 includes a lateral protrusion 333 extending laterally from the top. The mounting component 330 may be attached to the photonic structure 200 using methods similar to those described above for the FAU 320. For example, the mounting component 330 is oriented within the photonic system 300 such that the lateral protrusion 333 may extend over (e.g., overhang or rest on) the photonic structure 200 and the photonic structure 200 may support the lateral protrusion 333. In this manner, the orientation of the mounting component 330 may also be considered “upside-down.” In some embodiments, the mounting component 330 may be secured to the photonic structure 200 using the optical glue 324, which will be described in greater detail below.

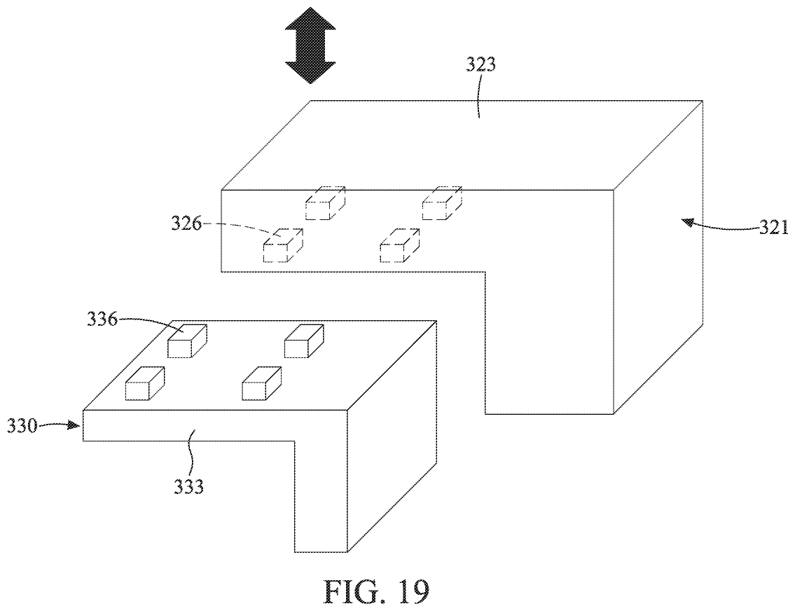

In some embodiments, the “L-shaped” FAU 320 covers the outer side of the mounting component 330 opposite the photonic structure 200. In some embodiments, the height H (in the Z-direction) of the FAU 320 may be larger than the height H1 (in the direction) of the mounting component 330, and/or the dimensions (e.g., the area in the X-Y plane) of the lateral protrusion 323 of the FAU 320 may be larger than or equal to the dimensions (e.g., the area in the X-Y plane) of the lateral protrusion 333 of the mounting component 330, but the disclosure is not limited thereto. In some embodiments, the FAU 320 is separated from the optical glue 324 by the mounting component 330. In other words, the FAU 320 is not directly connected to the photonic structure 200 through the optical glue 324 like the embodiment of FIG. 16. In some embodiments, the FAU 320 is removably connected to the mounting component 330 through a pair of matching connection (e.g., engagement) structures at the interface between the mounting component 330 and the FAU 320. As an example, FIG. 19 illustrates a perspective exploded view of a portion of the FAU assembly 420 of FIG. 18, showing connection structures 326, 336 between the mounting component 330 and the FAU 320, in accordance with some embodiments.

In some embodiments, connection structures 336 are formed on the top surface of the lateral protrusion 333 of the mounting component 330, and connection structures 326 are formed on the bottom surface of the lateral protrusion 323 of the FAU 320 (e.g., the cover plate 321), as shown in FIG. 19. The arrangement of the connection structures 336 corresponds to the arrangement of the connection structures 326, and the shape and size of one connection structure 326 matches the shape and size of the corresponding connection structure 336. For example, in the example of FIG. 19, the connection structures 336 of the mounting component 330 include four protrusions or connecting pins protruding from the top surface of the lateral protrusion 333, arranged in a rectangular matrix, and having a rectangular cross-sectional shape. Correspondingly, the connection structures 326 include four recesses or mating holes recessed form the bottom surface of the lateral protrusion 323, arranged in a rectangular matrix, and having a rectangular cross-sectional shape. Other numbers, arrangements, cross-sectional shapes (e.g., circular, triangular, polygonal) and sizes of the connection structures 326, 336 may be used, and are not limited to the examples shown in FIG. 19.

In some embodiments, each connection structure 336 (e.g., protrusion/connecting pin) fits tightly into the corresponding connection structure 326 (e.g., recess/mating hole) during assembly. In some embodiments, no adhesive is applied at the interface between the mounting component 330 and the FAU 320. In this manner, the FAU 320 may be connected (e.g., attached) to the mounting component 330 by engaging the connection structures 326, 336, and may be separated from the mounting component 330 by detaching the connection structures 326, 336 as desired (for example, when the optical fibers 318 need to be replaced or repaired). The assembly and disassembly directions of the FAU 320 are indicated by double-headed arrows in FIG. 19.

In some other embodiments, the functions of the connection structures 326, 336 shown in FIG. 19 can be reversed, i.e., the connection structures 326 (e.g., protrusions/connecting pins) may be provided on the bottom surface of the lateral protrusion 323 of the cover plate 321, and the connection structures 336 (e.g., recesses/mating holes) may be provided on the top surface of the lateral protrusion 333 of the mounting component 330. This reversal will not change the assembly of the FAU assembly 420.

In some embodiments, after the mounting component 330 has been secured to the photonic structure 200 by the optical glue 324, the FAU 320 is attached (e.g., connected) to the mounting component 330. In some cases, the installation of the mounting component 330 may be performed at a step prior to attaching the lid 310 and forming the electrical connectors 308, and the attachment of the FAU 320 may be performed at a step after the lid 310 is attached and the electrical connectors 308 are formed. In such cases, the material of the mounting component 330 may be chosen to be able to withstand the high temperature conditions (e.g., reflow temperatures) in which the electrical connectors 308 are formed, including, for example, glass, ceramic, polymer, metal, or other suitable materials. Other assembly sequences and assembly timings of the mounting component 330 and/or the FAU 320 may be used. In some other embodiments, the mounting component 330 and the FAU 320 of the FAU assembly 420 are assembled first and then attached together to the photonic structure 200 (for example, in the step illustrated in FIG. 16).

It should be understood that assembly tolerance (e.g., between the connection structures 326 and 336) inevitably exists in the assembly of the mounting component 330 and the FAU 320, which will affect the accuracy of optical coupling between the optical fibers 318 held by the FAU 320 and the corresponding edge couplers 107 within the photonic structure 200. For example, in some cases, said optical coupling accuracy requirement is about 0.5 μm, but said assembly tolerance may be higher than about 2 μm, causing the optical coupling accuracy to exceed the accuracy requirement. To solve the above issue (i.e., reduced optical coupling), the FAU assembly 420 further includes one or more micro-lenses 340, which can collimate or focus light signals from optical fibers 318, thereby improving the accuracy of optical coupling, in some embodiments shown in FIG. 18. In some cases, by using the micro-lens 340, the accuracy of optical coupling between an optical fiber 318 held by the FAU assembly 420 and the corresponding edge coupler 107 meets the accuracy requirement (i.e., 0.5 μm).

In some embodiments, each of the micro-lenses 340 is disposed between an optical fiber 318 and the corresponding edge coupler 107. Although not shown, the micro-lenses 340 may be arranged in an array or similar configuration corresponding to the arrangement of the optical fibers 318 (e.g., in the Y-direction) and the arrangement of the edge couplers 107 (e.g., in the Y-direction). For example, each micro-lens 340 is vertically aligned with the corresponding optical fiber 318 and edge coupler 107, i.e., they are substantially at the same level or height (e.g., the corresponding centers of the micro-lens 340, optical fiber 318, and edge coupler 107 are at the same level in the Z-direction), as shown in FIG. 18. In some embodiments, the micro-lenses 340 may be formed of glass (i.e., SiO₂) or the like. In some embodiments, the reflective index of the micro-lenses 340 may be in a range between 1 and 3.5, although other ranges may be used. Further details of the micro-lenses 340 are not discussed here.

In some embodiments, the micro-lenses 340 are attached (e.g., secured) to the bottom of the mounting component 330 using a glue 342, which may be an adhesive, an optical glue, or the like. In some embodiments, the heights H, H1 of the FAU 320 and mounting component 330 are formed such that each of the micro-lenses 340 secured to the bottom of the mounting component 330 is vertically aligned with the corresponding optical fiber 318 and edge coupler 107, for example, after the assembly and attachment of the FAU 420, as shown in FIG. 18. In some embodiments, an optional protective material 344 may be deposited on the bottom of the mounting component 330 around the micro-lenses 340. The protective material 344 can prevent the micro-lenses 340 from being damaged. In some embodiments, the micro-lenses 340 are first covered with the protective material 344, and then secured to the mounting component 330. In this manner, the micro-lenses 340 are separated from the mounting component 330 by the protective material 344. The protective material 344 may be an optical glue, an epoxy, or other suitable material that allows light to pass through. In some embodiments, the protective material 344 may be a material similar to the glue 342. In some other embodiments, the protective material 344 may be omitted.

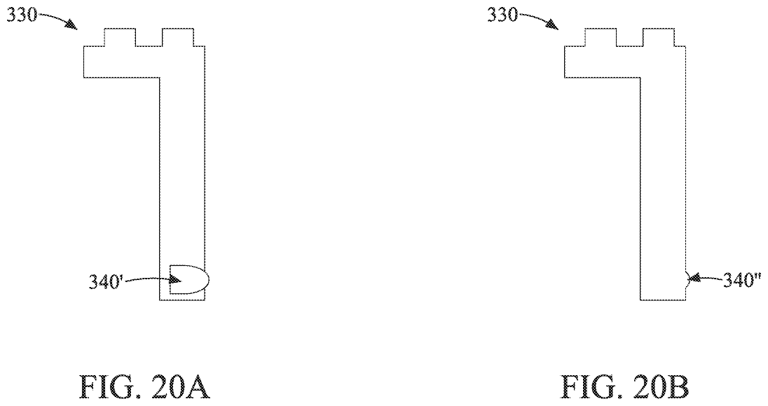

In other embodiments, the micro-lenses 340 may be integrated with the mounting component 330 in different ways than shown in FIG. 18. For example, FIGS. 20A and 20B illustrate cross-sectional views of a mounting component 330 integrated with a micro-lens (340′ or 340″), in accordance with some embodiments. In the example of FIG. 20A, the micro-lens 340′ may be embedded within the mounting component 330 and close to the bottom of the mounting component 330. For example, the mounting component 330 (e.g., comprises a polymer material) may be formed by a molding process (e.g., injection molding), and the micro-lens 340′ may be positioned in the desired location in the mold before the molding process. Therefore, the micro-lens 340′ can be embedded within the mounting component 330 after the molding process. In the example of FIG. 20B, the micro-lens 340″ may be formed in or on the surface of the mounting component 330 (facing the FAU 320) and close to the bottom of the mounting component 330. For example, the lens surface of the micro-lens 340″ may be directly formed in or on the surface of the mounting component 330 (e.g., glass material) using laser (direct) writing. Details of the laser writing process are well-known in the art and are not described here. Other suitable processes for integrating the micro-lenses 340 within the mounting component 330 may be used.

Referring back to FIG. 18, the optical glue 324 may be deposited between the photonic structure 200 and the mounting component 330 to secure the mounting component 330 to the photonic structure 200. In some embodiments, the optical glue 324 may extend between the sidewall of the photonic structure 200 (near the edge couplers 107) and the adjacent surface of the mounting component 330. Also, the optical glue 324 may extend between the top surface of the photonic structure 200 and the bottom surface of the lateral protrusion 333 of the mounting component 330. In some embodiments, the optical glue 324 may also extend between the sidewall of the photonic structure 200 (near the edge couplers 107) and the adjacent surfaces of the micro-lenses 340 or the adjacent surface of the protective material 344 (if present) to facilitate optical coupling between an edge coupler 107 and its corresponding micro-lens 340. In some embodiments, the optical glue 324 may be deposited after aligning one or more micro-lenses 340 with corresponding edge couplers 107 within the photonic structure 200 using the mounting component 330, as shown in FIG. 18.

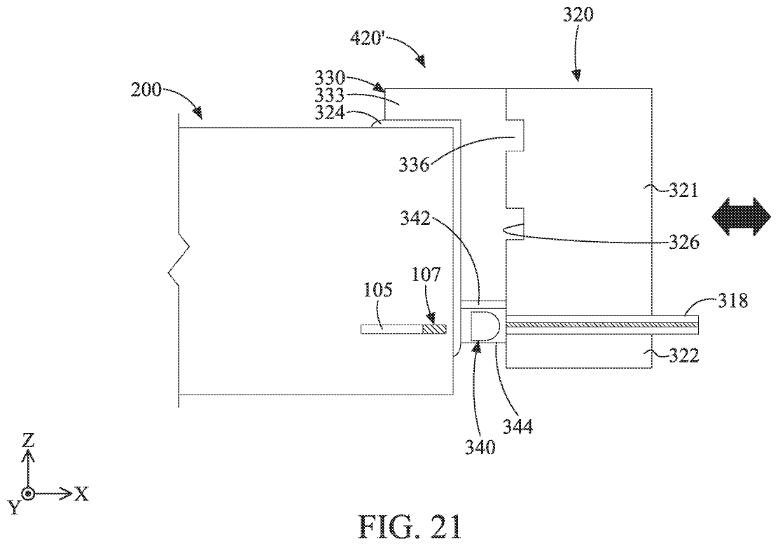

In some other embodiments, the connection structures 326, 336 may be provided at other positions at the interface between the mounting component 330 and the FAU 320. For example, FIG. 21 illustrates a cross-sectional view of a FAU assembly 420′ similar to the FAU assembly 420 of FIG. 18, except that the connection structures 326, 336 are formed on adjacent sidewalls of the mounting component 330 and the FAU 320′. Details of the connection structures 326, 336 can be found in the discussion of FIG. 19, and thus not repeated here. As shown in FIG. 21, the lateral protrusion 323 of the FAU 320′ is not present, although the lateral protrusion 323 may be present in some other embodiments. The assembly and disassembly directions of the FAU 320′ are indicated by double-headed arrows in FIG. 21. Many of the assembly steps, components, or materials of the FAU assembly 420′ are similar to those described previously for the FAU assembly 420, and therefore some similar details are not repeated here.

As mentioned above, the embodiment FAU assembly 420/420′ includes a mounting component 330 secured (e.g., edge-mounted) near a sidewall of the photonic structure 200 (which may also referred to as a “fixed part”), and a FAU 320/320′ removably connected to the mounting component 330 (which may also referred to as a “movable part”). In this manner, the FAU 320/320′ may be separated or removed from the mounting component 330 as desired, for example, when the optical fibers 318 need to be replaced or repaired. In addition, the embodiment FAU assembly 420/420′ also includes one or more micro-lenses 340 provided between (e.g., adjacent to) the optical fibers 318 held by the FAU 320/320′ and the corresponding edge couplers 107 within the photonic structure 200 to improve optical coupling therebetween, which otherwise may be affected by assembly tolerance of the FAU 320/320′ and the mounting component 330. Furthermore, the embodiment FAU assembly 420/420′ is attached to the photonic structure 200 in an “upside-down” (i.e., overhang) manner and is not placed on (i.e., spaced apart from) the package substrate 302 (see FIG. 16), which helps to reduce the space taken up by the FAU assembly 420/420′ on the package substrate 302. Therefore, a size reduction of the photonic system 300 is achieved.

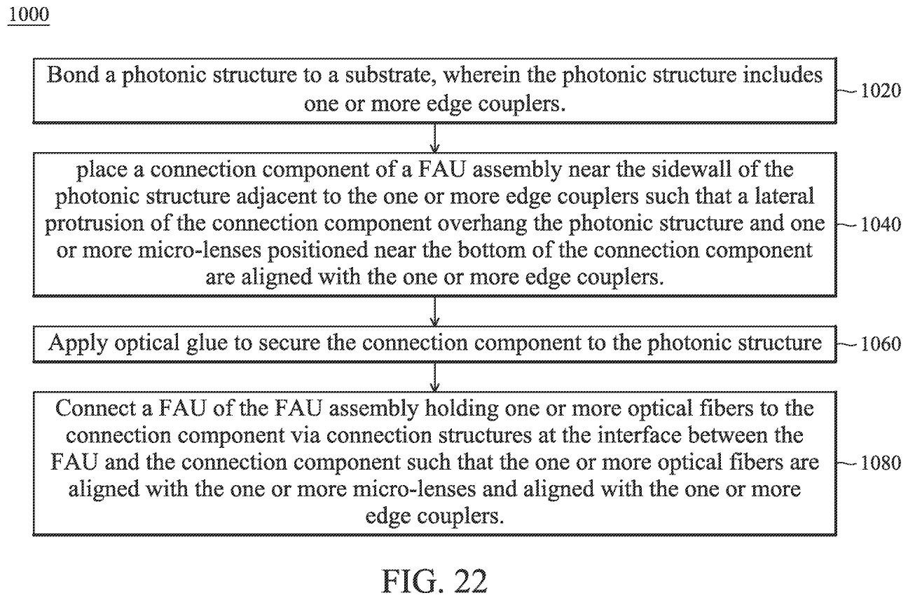

FIG. 22 illustrates a flow chart of a method 1000 of coupling one or more optical fibers to a photonic structure, in accordance with some embodiments. The method 1000 includes operation 1020 in which a photonic structure (e.g., the photonic structure 200) is bonded to a substrate (e.g., the package substrate 302), wherein the photonic structure 200 includes one or more edge couplers (e.g., edge couplers 107). The method 1000 includes operation 1040 in which a connection component (e.g., the connection component 330) of a FAU assembly (e.g., the FAU assembly 420 or 420′) is placed near the sidewall of the photonic structure 200 adjacent to the one or more edge couplers 107 such that a lateral protrusion (e.g., the lateral protrusion 333) of the connection component 330 overhang the photonic structure 200 and one or more micro-lenses (e.g., the micro-lenses 340, 340′ or 340″) positioned near the bottom of the connection component 330 are aligned with the one or more edge couplers 107. The method 1000 includes operation 1060 in which optical glue (e.g., the optical glue 324) is applied to secure the connection component 330 to the photonic structure 200. The method 1000 includes operation 1080 in which a FAU (e.g., the FAU 320 or 320′) of the FAU assembly 420 or 420′ holding one or more optical fibers (e.g., the optical fibers 318) is connected to the connection component 330 through connection structures (e.g., the connection structures 326 and 336) at the interface between the FAU 320/320′ and the connection component 330 such that the one or more optical fibers 318 are aligned with the one or more micro-lenses 340/340′/340″ and aligned with the one or more edge couplers 107.

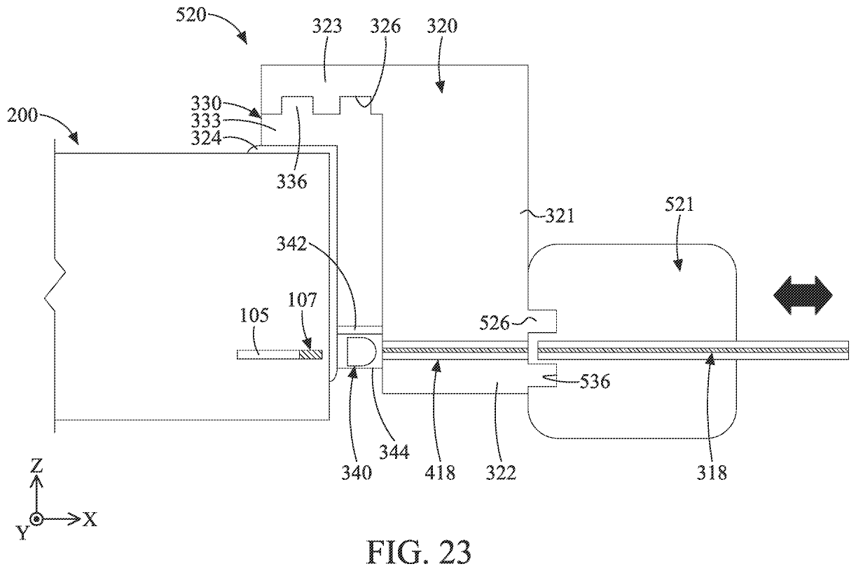

FIG. 23 illustrates a cross-sectional view of a FAU assembly 520 in accordance with some embodiments. The FAU assembly 520 is similar to the FAU assembly 420 of FIG. 18, except that the optical fibers 318 are coupled to the optical fibers 418 (which may also be considered as “waveguides”) held by the FAU 320 using an additional fiber connector 521 (e.g., a multi-fiber push on connector (MPO)). As shown in FIG. 23, the fiber connector 521 may be attached (e.g., connected) to the FAU 320, and another pair of matching connection structure 526, 536 is provided at the interface between the fiber connector 521 and the FAU 320, which may be similar to the connection structures 326, 336 described above, to facilitate assembly and disassembly of the fiber connector 521 (the assembly and disassembly directions of the fiber connector 521 are indicated by double-headed arrows in FIG. 23). For example, the fiber connector 521 may be connected to the FAU 320 by engaging the connection structures 526, 536, and may be separated from the FAU 320 by detaching the connection structures 526, 536 as desired (for example, when the optical fibers 318 need to be replaced or repaired). In some embodiments, the connection structures 526 are protrusions/connecting pins protruding from a sidewall of the FAU 320, and the connection structures 536 are recesses/mating holes recessed from the corresponding sidewall of the fiber connector 521, as shown in FIG. 23. In some other embodiments, the functions of the connection structures 526, 536 may be reversed. The connection structures 526 may be formed on one or both of the cover plate 321 and base plate 322 of the FAU 320, in some embodiments. Although the connection structures 326, 336 are present in this embodiment, they may not be present in some other embodiments. Many of the assembly steps, components, or materials of the FAU assembly 520 are similar to those described previously for the FAU assembly 420, and therefore some similar details are not repeated here.

It should be understood that the structures, configurations and the manufacturing methods described herein are only illustrative, and are not intended to be, and should not be construed to be, limiting to the present disclosure. Many alternatives and modifications will be apparent to those skilled in the art, once informed by the present disclosure. For example, various features in the above-mentioned different embodiments can be combined arbitrarily.

Embodiments of the FAU assembly may have advantages. As mentioned above, the FAU assembly allows the FAU holding optical fibers to be easily removed or separated from the connecting component secured to the photonic structure, for example, when the optical fibers need to be replaced or repaired. Additionally, micro-lenses are provided near the bottom of the connecting component to improve the accuracy of edge optical coupling between the optical fibers held by the FAU and the corresponding edge couplers within the photonic structure, which otherwise may be affect by assembly tolerance of the FAU and the connecting component. In some embodiments, the FAU assembly may be overhang the photonic structure rather than placed on the substrate of the photonic system, which reduces the substrate footprint. Accordingly, the package size of the photonic system can be reduced. Furthermore, compared to the case where the micro-lens and the FAU are placed on the substrate of the photonic system, the FAU assembly places the micro-lens and the corresponding optical fiber in close proximity to each other and directly attached to the sidewall of the photonic structure, which also helps shorten the optical transmission distance.

In accordance with some embodiments, a photonic system is provided. The photonic system includes a substrate and a photonic structure bonded to the substrate, wherein the photonic structure includes one or more edge couplers. The photonic system also includes a fiber array unit (FAU) assembly attached to the sidewall of the photonic structure near the one or more edge couplers. The FAU assembly includes a connection component, a FAU holding one or more optical fibers, and one or more micro-lenses. The connection component is secured to the sidewall through optical glue. The FAU is removably attached to the connection component through a pair of matching connection structures at an interface between the FAU and the connecting component. The one or more micro-lenses are provided near the bottom of the connecting component and between the one or more edge couplers and the one or more optical fibers.

In accordance with some embodiments, a fiber array unit (FAU) assembly is provided. The FAU assembly includes a FAU holding one or more optical fibers. The FAU assembly includes a connecting component disposed adjacent to a sidewall of the FAU, wherein a pair of matching connection structures is formed at an interface between the FAU and the connecting component to allow assembly and disassembly of the FAU and the connecting component. The FAU assembly also includes one or more micro-lenses provided near the bottom of the connecting component and aligned with the one or more optical fibers.

In accordance with some embodiments, a method of coupling one or more optical fibers to a photonic structure is provided. The method includes bonding the photonic structure to a substrate, wherein the photonic structure includes one or more edge couplers. The method includes placing a connection component of a fiber array unit (FAU) assembly near the sidewall of the photonic structure adjacent to the one or more edge couplers such that one or more micro-lenses positioned near the bottom of the connection component are aligned with the one or more edge couplers. The method includes depositing an optical glue between the connecting component and the photonic structure. The method also includes connecting a FAU of the FAU assembly holding the one or more optical fibers to the connecting component through connection structures at an interface between the FAU and the connection component such that the one or more optical fibers are aligned with the one or more micro-lenses and aligned with the one or more edge couplers.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonic system, comprising:
a substrate;
a photonic structure bonded to the substrate, wherein the photonic structure comprises one or more edge couplers; and
a fiber array unit (FAU) assembly attached to a sidewall of the photonic structure near the one or more edge couplers, wherein the FAU assembly comprises:
a connection component secured to the sidewall through an optical glue;
a FAU holding one or more optical fibers, wherein the FAU is removably attached to the connection component through a pair of matching connection structures at an interface between the FAU and the connecting component; and
one or more micro-lenses provided near a bottom of the connecting component and between the one or more edge couplers and the one or more optical fibers.

2. The photonic system as claimed in claim 1, wherein no adhesive is applied at the interface between the FAU and the connecting component.

3. The photonic system as claimed in claim 1, wherein the connection component comprises a lateral protrusion extending to an upper surface of the photonic structure.

4. The photonic system as claimed in claim 3, wherein the optical glue extends between the sidewall of the photonic structure and the connection component, and also extends between the upper surface of the photonic structure and a bottom surface of the lateral protrusion.

5. The photonic system as claimed in claim 1, wherein the pair of matching connection structures comprises a plurality of protrusions and a plurality of recesses corresponding to each other, the protrusions are formed on one of the FAU and the connecting component, and the recesses are formed on the other of the FAU and the connecting component.

6. The photonic system as claimed in claim 5, wherein the connection component comprises a lateral protrusion extending to an upper surface of the photonic structure, and the FAU comprises a lateral protrusion covering the lateral protrusion of the connection component, and
wherein the protrusions and the recesses are formed at the interface between the lateral protrusion of the connection component and the lateral protrusion of the FAU.

7. The photonic system as claimed in claim 5, wherein the protrusions and the recesses are formed at the interface between adjacent sidewalls of the connection component and the FAU.

8. The photonic system as claimed in claim 1, wherein the one or more micro-lenses are secured to the bottom of the connection component through an adhesive.

9. The photonic system as claimed in claim 1, wherein the one or more micro-lenses are embedded within the connection component.

10. The photonic system as claimed in claim 1, wherein the one or more micro-lenses are formed in or on a surface of the connection component facing the FAU.

11. The photonic system as claimed in claim 1, wherein the optical glue extends between the sidewall of the photonic structure and the one or more micro-lenses.

12. The photonic system as claimed in claim 1, wherein the FAU assembly is spaced apart from an upper surface of the substrate where the photonic structure is bonded.

13. A fiber array unit (FAU) assembly, comprising:
a FAU holding one or more optical fibers;
a connecting component adjacent to a sidewall of the FAU, wherein a pair of matching connection structures is formed at an interface between the FAU and the connecting component to allow assembly and disassembly of the FAU and the connecting component; and
one or more micro-lenses provided near a bottom of the connecting component and aligned with the one or more optical fibers.

14. The FAU assembly as claimed in claim 13, wherein the one or more micro-lenses are secured to the connecting component.

15. The FAU assembly as claimed in claim 13, wherein the connecting component comprises a lateral protrusion laterally extending from a top of the connecting component, and the FAU comprises a lateral protrusion laterally extending from a top of the FAU and covering the lateral protrusion of the connecting component, and
wherein the pair of matching connection structures is formed at the interface between the lateral protrusion of the connection component and the lateral protrusion of the FAU.

16. The FAU assembly as claimed in claim 13, further comprising:
a fiber connector attached to a sidewall of the FAU opposite the connection component, wherein another pair of matching connection structures is formed at an interface between the FAU and the fiber connector to allow assembly and disassembly of the FAU and the fiber connector.

17. A method of coupling one or more optical fibers to a photonic structure, comprising:
bonding the photonic structure to a substrate, wherein the photonic structure comprises one or more edge couplers;
placing a connection component of a fiber array unit (FAU) assembly near a sidewall of the photonic structure adjacent to the one or more edge couplers such that one or more micro-lenses positioned near a bottom of the connection component are aligned with the one or more edge couplers;
depositing an optical glue between the connecting component and the photonic structure; and
connecting a FAU of the FAU assembly holding the one or more optical fibers to the connecting component through connection structures at an interface between the FAU and the connection component such that the one or more optical fibers are aligned with the one or more micro-lenses and aligned with the one or more edge couplers.

18. The method as claimed in claim 17, wherein the FAU assembly comprising the FAU, the connecting component and the one or more micro-lenses is spaced apart from the substrate.

19. The method as claimed in claim 17, wherein the FAU is removably connected to the connecting component through the connection structures without adhesive.

20. The method as claimed in claim 19, further comprising:
separating the FAU from the connection component when the one or more optical fibers need to be replaced or repaired.
